(19) United States
(12) Patent Application Publication
(10) Pub. No.: US 2026/0368183 A1
(43) Pub. Date: Nov. 19, 2026

(54) METADATA ENRICHMENT BY EDGE SITES IN AN EDGE NETWORK

(71) Applicant: International Business Machines Corporation, Armonk, NY (US)

(72) Inventors: Paul Llamas Virgen, Guadalajara (MX); Santiago Nicolas Valle Contreras, Guadalajara (MX)

(21) Appl. No.: 19/209,506

(22) Filed: May 15, 2025

(51) Int. Cl. G06F 16/2457; G06F 16/27

(52) U.S. Cl. CPC G06F 16/24573; G06F 16/27

(57) ABSTRACT

A method, according to one embodiment, comprises causing edge sites of an edge network to analyze metadata extracted from the edge sites, and causing the edge sites to propose a first set of tags for files and/or objects associated with the analyzed metadata, where the first set of tags are based on the analysis. The method further comprises causing the edge sites to merge and/or compare the tags to identify a consolidated second set of tags and a portion of the analyzed metadata, and ingesting the consolidated second set of tags and the portion of the analyzed metadata at a centralized system, where the centralized system does not contribute to the analysis of the analyzed metadata. A computer program product, according to another embodiment, comprises one or more computer-readable storage media, and program instructions stored on the one or more storage media to perform the foregoing method.

### BACKGROUND

The present invention relates to edge networks, and more specifically, this invention relates to metadata.

Metadata is described as the data of the data and/or the data that describes the data. Metadata is particularly useful for obtaining information about the data content of an object or resource. Use of metadata is enabled by structuring the metadata in a manner that can be used to describe, explain, locate the actual storage location, locate the virtual storage location, and/or retrieve a data resource.

Depending on the use case, metadata is often stored at various locations. In some of these use cases, these storage locations of the metadata include locations within the data that the metadata is associated with, e.g., metadata is embedded within a file and/or image that the metadata is associated with. In some other of these use cases, these storage locations of the metadata include a separate database and/or storage location, e.g., metadata may be stored in a separate file than the file that the metadata is associated with.

### SUMMARY

A method, according to one embodiment, comprises causing edge sites of an edge network to analyze metadata extracted from the edge sites, and causing the edge sites to propose a first set of tags for files and/or objects associated with the analyzed metadata, where the first set of tags are based on the analysis. The method further comprises causing the edge sites to merge and/or compare the tags to identify a consolidated second set of tags and a portion of the analyzed metadata, and ingesting the consolidated second set of tags and the portion of the analyzed metadata at a centralized system, where the centralized system does not contribute to the analysis of the analyzed metadata.

A computer program product, according to another embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for metadata enrichment by edge sites in an edge network.

In one general embodiment, a method comprises causing edge sites of an edge network to analyze metadata extracted from the edge sites, and causing the edge sites to propose a first set of tags for files and/or objects associated with the analyzed metadata, where the first set of tags are based on the analysis. The method further comprises causing the edge sites to merge and/or compare the tags to identify a consolidated second set of tags and a portion of the analyzed metadata, and ingesting the consolidated second set of tags and the portion of the analyzed metadata at a centralized system, where the centralized system does not contribute to the analysis of the analyzed metadata.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as metadata enrichment determination code of block 150 for metadata enrichment by edge sites in an edge network. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

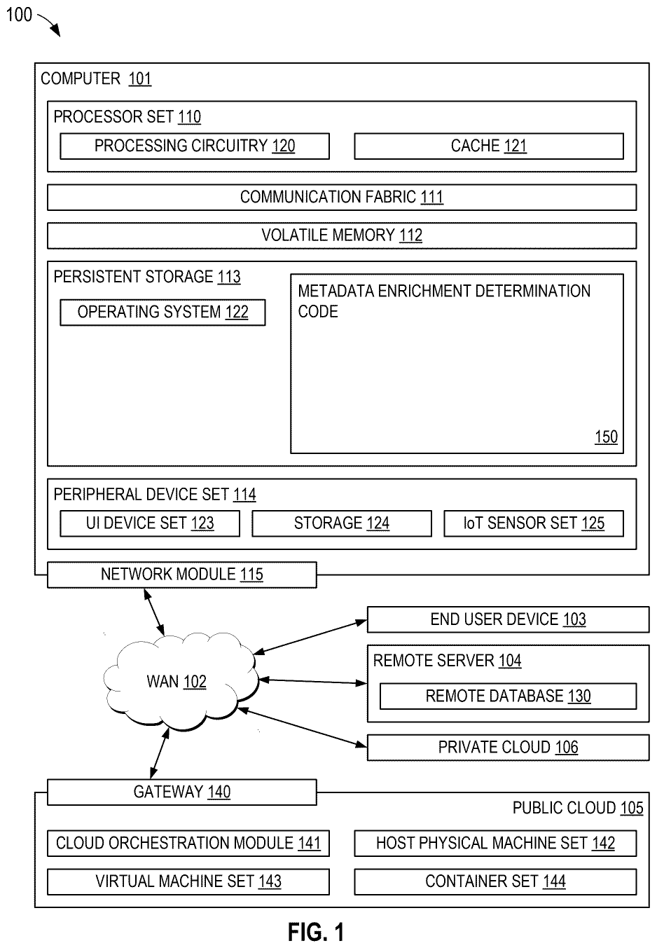

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

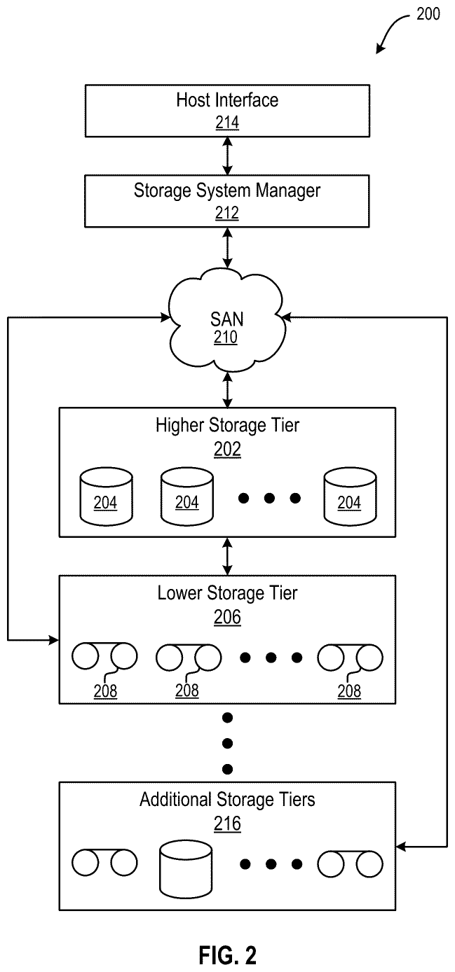

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere herein, metadata is described as the data of the data and/or the data that describes the data. Metadata is particularly useful for obtaining information about the data content of an object or resource. Use of metadata is enabled by structuring the metadata in a manner that can be used to describe, explain, locate the actual storage location, locate the virtual storage location, and/or retrieve a data resource.

Depending on the use case, metadata is often stored at various locations. In some of these use cases, these storage locations of the metadata include locations within the data that the metadata is associated with, e.g., metadata is embedded within a file and/or image that the metadata is associated with. In some other of these use cases, these storage locations of the metadata include a separate database and/or storage location, e.g., metadata may be stored in a separate file than the file that the metadata is associated with.

The importance of having metadata of resources that are used at low and high scale becomes an issue as the extent of unstructured data that exists is constantly increasing. For context, unstructured data may be defined as a collection of data for which data that would otherwise be used by a machine to understand the collection of data does not exist. Typical examples of unstructured data includes audio files, video files, unstructured text documents, etc. In order to establish structure for such data, metadata can be gathered from a file system itself. However, when considering metadata gathering at scale there are several different issues that arise. For example, the metadata is typically distributed across several nodes (distributed metadata), which leads to the occurrence of synchronization issues when gathering the metadata. These synchronization issues introduce latency into a storage system that includes the nodes. Network stability is another issue that arises while gathering metadata. Non near-to-cluster data sources create even further latencies while gathering metadata in the storage system.

In sharp contrast to the deficiencies of the technical field described above, the embodiments and approaches described herein include techniques that include performing distributed metadata enrichment at the edge of a storage system. These techniques enable the development of a semantic relationship for distributed data sources which may be computed at the edge. In some approaches, these techniques include tagging files with semantic information (what the file contains and/or a relevance of the information). These techniques additionally include associating business and/or technical context with the data (e.g., linking customer and/or transaction details). Yet furthermore, these techniques include adding classification and sensitivity levels (e.g., for security, privacy, and/or regulatory needs). These techniques may furthermore include performing multiprocessing for edge scalability.

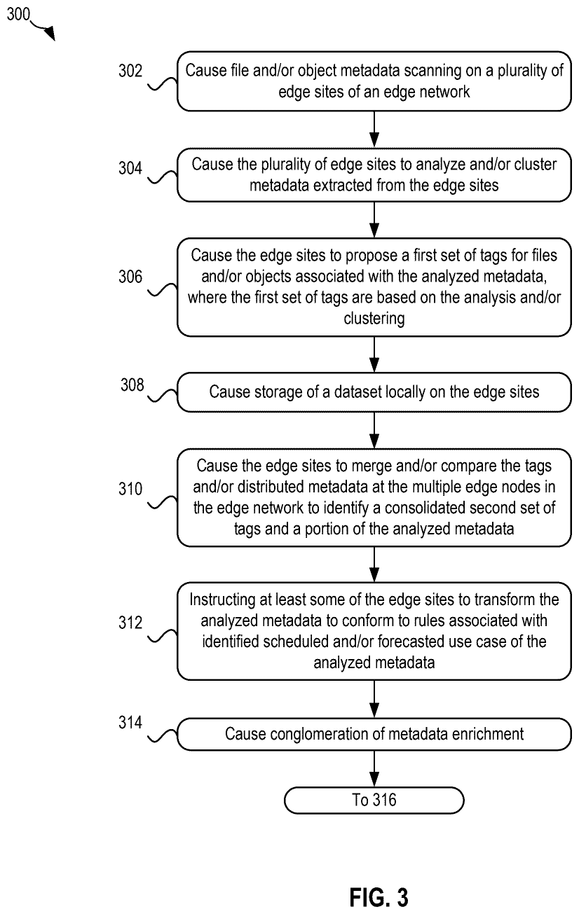

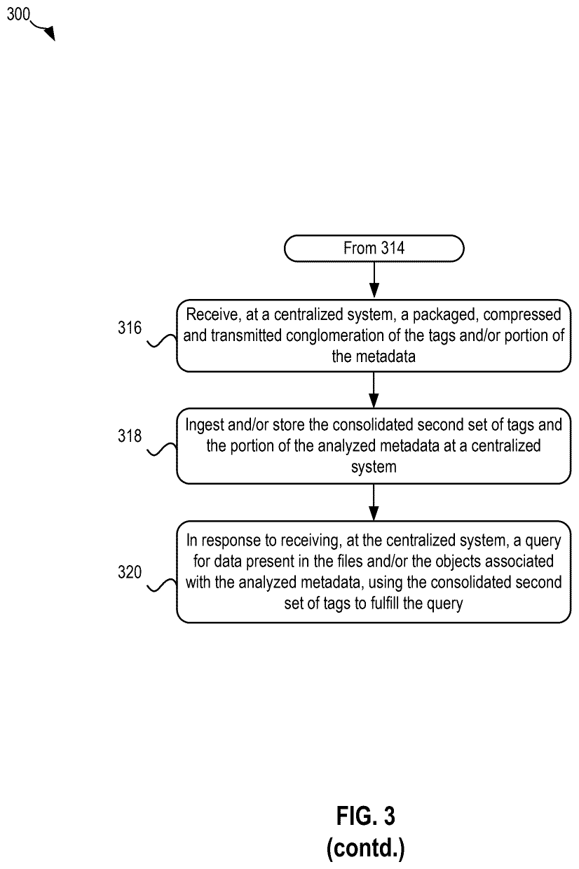

Now referring to FIG. 3, a flowchart of a method 300 is shown according to one embodiment. The method 300 may be performed in accordance with aspects of the present invention in any of the environments depicted in FIGS. 1-4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 and the techniques of other embodiments and approaches described herein may preferably be performed within an infrastructure associated with edge sites. For example, in some preferred approaches, the infrastructure is an edge network that includes two or more edge sites that are in communication with a centralized system. Note that some techniques and/or operations described herein may, in some approaches, be performed by instructing a single edge site. However, in some preferred approaches, the techniques of method 300 include at least some operations performed with respect to two or more edge sites. The edge sites may be edge devices of a type that would become apparent to one of ordinary skill in the art after reading the descriptions herein, e.g., routers, processing circuits that include a sensor, IoT devices, etc. However, at least some of, and preferably all of these edge sites preferably have at least some processing resources that are capable of searching for metadata, analyzing metadata, transmitting metadata and tags and/or communicating with the centralized system (as well as the other edge sites). Meanwhile, the centralized system may, in some approaches, be a server, a computer, a virtual machines, clusters, grids, relatively high performance computing (HPC) centralized systems, etc., that is in communication with the edge sites.

Operations of method 300 preferably enable enrichment of distributed metadata for unstructured data within the edge network, where the analysis performed for the enrichment is performed by the edge site(s) rather than the centralized system. As will be described elsewhere below, by the analysis being performed by the edge site(s) and not by the centralized system, significant latency and network traffic that would otherwise be consumed in transmitting unstructured metadata from the edge site(s) to the centralized system is mitigated.

Operation 302 includes causing file and/or object metadata scanning on a plurality of edge sites of an edge network. In some approaches, the scanning is caused to be performed by instructing the edge sites of the edge network to perform the scanning. More specifically, the edge sites may be issued an ongoing instruction to perform the scanning, e.g., at all times, periodically, etc., in some approaches, while in other approaches, the edge sites may be issued such instructions on an event driven basis, e.g., in response to a determination that use of metadata, by the edge sites and/or centralized system for accessing data associated with the metadata, results in less than a predetermined degree of accuracy. In other words, the instructions may be issued in response to a determination that a metadata copy stored on and/or used by the centralized system has become outdated. In some other approaches, the instructions may be issued based on an event occurring that includes the amount of unstructured data in the edge network exceeding a predetermined threshold.

The metadata that is scanned for by the edge sites, in some approaches, includes metadata stored on the edge sites and/or stored on a database used by the edge sites. However, the metadata scanning is preferably not performed by the centralized system. In some approaches, the scanning includes performing single entity file and/or object metadata scanning and extraction. During this scanning for metadata, one or more of the edge sites may begin by scanning each file and object on a single edge entity (e.g., a device or node) for metadata. In some preferred approaches, each edge site preferably scan their own files and/or objects. These files and/or objects that are scanned may, in some approaches, include attributes such as, e.g., file name, size, creation and/or modification date, content type, and/or other available unstructured data that would become apparent to one of ordinary skill in the art after reading the descriptions herein.

Operation 302, in some approaches, additionally and/or alternatively includes causing file and/or object metadata extraction during and/or after the scanning of the edge sites of the edge network. This caused extraction of metadata, in some approaches, comprises extracting meaningful information from files using one or more predetermined techniques. For example, in some approaches, a first of these techniques includes natural language processing (NLP) for text, where the text of logs, files, databases, etc., is processed during the NLP. In another approach, these techniques may additionally and/or alternatively include image recognition for media files stored at and/or used by the edge sites. In yet another approach, these techniques may additionally and/or alternatively include format-specific parsing for structured content e.g., such as XML, JSON, etc. In some approaches, the metadata extracted from the edge sites includes metadata associated with files and/or objects tag files.

It should be noted that, in some approaches, the files and/or objects may be shared among the edge sites and/or copies of the files and/or objects may be stored across more than one of the edge sites. Accordingly, a workload associated with the scanning may, in some approaches, be divided using a trained artificial intelligence (AI) model (where the techniques described elsewhere herein involving use of the AI model may be modified to apply to division of the workload associated with the scanning).

Operation 304 comprises causing, e.g., instructing, a plurality of edge sites of an edge network to analyze metadata extracted from the edge sites. It should be noted that, in preferred approaches, the centralized system does not contribute to the analysis of the analyzed metadata. The instructions may specify one or more of the analysis techniques described below for analyzing the metadata.

The edge sites may, in some approaches, be caused to individually (single edge entity) perform metadata analysis of the extracted metadata. The metadata analysis, in some approaches, includes the edge sites performing an initial analysis on the extracted metadata using machine learning (ML) and/or rule-based systems to identify patterns in the metadata. These patterns may include one or more of, e.g., types, formats, and keywords, in some approaches.

It should be noted that, in some preferred approaches, the analysis of the metadata extracted from the edge sites was initially and/or otherwise scheduled to be performed by the centralized system. However, in order to reduce an amount of metadata and/or data associated with the metadata that is transmitted through the edge network, available processing resources of the edge sites may be identified and used, thereby enabling the analysis of the metadata to be offloaded to be performed by the edge sites rather than being performed by the centralized system.

In order ensure that the offload of the metadata analysis from the centralized system to the edge sites does not increase a latency of a workload associated with performing the analysis on the metadata, in some approaches, different portions of the workload of the analysis of the metadata may be distributed to the edge sites according to the amount of resources that are available on the different edge sites. Techniques for performing this distribution are detailed below.

In some approaches, the operations of method 300 may be performed by an AI model that is trained using a predetermined training set of data. In some approaches, method 300 includes using a training set of data to train an AI model to analyze the edge sites to dynamically determine available processing resources of the edge sites. During this training, the AI model may be caused to consume historical logs about the edge sites and/or other operational log events associated with the edge network in order to forecast processing resources of the edge sites and/or durations of time that these resources will be available. Initial training may include reward feedback that may, in some approaches, be implemented using a subject matter expert (SME) that generally understands whether the AI model achieves success within a select of estimations based on the training set of data, e.g., one to ten estimations. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. For example, in response to a determination that the AI model achieves at least a predetermined threshold of accuracy of analyzing the edge sites to dynamically determine the available processing resources of the edge sites, method 300 comprises deploying the AI model.

The files and/or objects that are scanned by the edge sites may, in some approaches, be distributed across the edge sites. For example, in some approaches, different copies of the same file may be stored at and/or be accessible to more than one of the edge sites. This way, the workload of analyzing the metadata associated therewith may be divided among the edge sites based on available processing resources of the edge sites. For example, in some approaches, method 300 comprises obtaining, from the AI model, the available processing resources of the edge sites. The AI model, in some approaches, queries this information. In some other approaches, the AI model may additionally and/or alternatively access a table that is dynamically updated to include this information. In some other approaches, the available processing resources of the edge sites is calculated by the AI model based on a current workload of the edge sites, e.g., a delta of the total resources of a given edge site and the resources of the edge site calculated as currently being used by the edge site. Accordingly, the causing the edge sites to analyze the metadata extracted from the edge sites, in some approaches, comprises instructing the edge sites to perform portions of the analysis, where the portions of the analysis are proportional to the available processing resources of the edge sites. Furthermore, in some approaches, the causing the edge sites to analyze the metadata extracted from the edge sites may additionally and/or alternatively comprise instructing the edge sites to perform multiprocessing for edge scalability to perform the portions of the analysis.

In some further approaches that utilize an AI model, in order to enable AI-data-ready ingestion, the data at the edge site may be pre-processed and prepared in a form that is ready to be consumed by an AI model at the centralized system. For example, in some approaches, this preprocessing includes preparing the set of tags and the portion of the analyzed metadata in a form that is consumable by LLMs, ML models, etc. In configurations in which the centralized system utilizes a plurality of different AI models, different edge sites may be caused, e.g., instructed, to prepare the different preprocessed types for the different models. Note that the centralized system does not contribute to this preprocessing, but rather, receives the consolidated second set of tags and the portion of the analyzed metadata at a centralized system in the preprocessed form.

For context, the AI model described above (which may be used to perform the “causing” based operations described herein) may be a neuromyotonic AI model that may improve performance of computer devices in an infrastructure associated with the edge network, because the neuromyotonic AI model may not need an SME and/or iteratively applied training with reward feedback in order to accurately perform operations described herein. Instead, the neuromyotonic AI model is configured to itself make determinations described in operations herein. Furthermore, in some approaches, the AI model is executed on a processing circuit of the centralized system. Weight values may, in some approaches, be used by the AI reasoning model to collect and analyze information and/or feedback potentially received from use of the analyzed metadata described herein. Such an AI model ensures that transmission workloads are decreased in the edge network, where the scale of such analysis and determinations would not otherwise be feasible for a human to perform. This is because humans are not able to efficiently analyze metadata of an entire edge network while monitoring the available resources of edge sites in a timely manner, and would otherwise incorporate processing delays and errors in the edge network in the process of attempting to do so. Accordingly, management of operations described herein is not able to be achieved by human manual actions.

The edge sites may, in some approaches, additionally and/or alternatively be caused to perform clustering of the extracted metadata. For context, during this clustering, the metadata may be clustered into logical groups based on predetermined and/or determined similarities. In order to determine such similarities, the edge sites may, using algorithms such as k-means, in some approaches. In some other approaches, these similarities may additionally and/or alternatively be determined and/or identified using hierarchical clustering of a type that would become apparent to one of ordinary skill in the art after reading the descriptions herein. In yet another approach, these similarities may additionally and/or alternatively be determined and/or identified using a DBSCAN clustering algorithm. Clusters may, depending on the approach, represent one or more categories, e.g., document types, themes, entities (e.g., people, places, products), etc.

Operation 306 includes causing, instructing, the edge sites to propose a first set of tags for files and/or objects associated with the analyzed metadata. The first set of tags are, in some approaches, based on the analysis, and the tags may include semantic information that includes and/or indicates file content and/or file relevance for files associated with the metadata having the tags.

It should be briefly noted that, although tags are proposed in some approaches and embodiments described herein, these operation(s) may additionally and/or alternatively be performed with respect to labels. For context, in some approaches, a tag may be used for classification purposes, while labels can be used for identification.

In some approaches, the tags are determined for enriching any of the analyzed metadata that is ultimately sent from the edge sites to the centralized system. Proposal of such tags for metadata enrichment, in some approaches, includes automatic tag proposal procedures. For example, based on the clustered groups of metadata, relevant tags for each file or object may be proposed. This process, in some approaches, may involve keyword extraction, semantic analysis, predefined taxonomies (e.g., product categories, customer types), etc. Tags may be appended to associated metadata and/or stored in an index and/or sent to the centralized system separately from at least some of the metadata, depending on the approach.

In some approaches, the tags are determined and assigned by an AI model trained (using a historical training set of data) to make such assignments. During this training, in some approaches, a human operator (such as a subject matter expert (SME)) may be allowed to review and/or adjust the proposed tags for refining an accuracy of the SME with respect to predetermined training business requirements.

In some approaches, the causing the edge sites to propose the first set of tags for the files and/or the objects associated with the analyzed metadata comprises identifying a scheduled and/or forecasted use case of the analyzed metadata (a future use of the analyzed metadata). For context, the scheduled and/or forecasted use case of the analyzed metadata may be identified in order to determine how to transform the metadata before sent out, e.g., in order to cause the available edge site resources to be used to condition the metadata for the use case and to ensure that only an extent of metadata that will be used is ultimately transmitted through the edge network from the edge sites to the centralized system.

In order to identify the scheduled and/or forecasted use case of the analyzed metadata, in some approaches, one or more of the edge sites are caused to identify a target function that the metadata will be used for. This identification may be caused by initiating an engine that forecasts an anticipated use and/or identifies a scheduled use of the metadata. More specifically, in some approaches, the identifying the scheduled and/or forecasted use case of the analyzed metadata comprises associating business and/or technical contexts with data present in the files and/or the objects associated with the analyzed metadata. An AI model may be caused, e.g., instructed and/or trained, to make such associations, in some approaches.

In another approach, in order to identify the scheduled and/or forecasted use case of the analyzed metadata, one or more of the edge sites are caused to classify metadata for a AI training set of data that is used to train an AI model to make such determinations. In one specific example, such an AI model may be caused and/or trained to identify a topic within the analyzed collected metadata (and/or associated document) and expand the metadata to conform to standards and/or rules. For example, an auditing of the analyzed metadata may reveal information that is used to determine that the scheduled and/or forecasted use case of the analyzed metadata includes use in banking systems.

In some approaches, method 300 includes instructing at least some of the edge sites to transform the analyzed metadata to conform to rules associated with the identified scheduled and/or forecasted use case of the analyzed metadata. This transformation may additionally and/or alternatively condition the analyzed metadata for a form that the analyzed metadata will be used in an environment associated with the identified scheduled and/or forecasted use case of the analyzed metadata. For example, assuming that the scheduled and/or forecasted use case of the analyzed metadata includes use in banking systems at least some of the analyzed metadata may be pre-encrypted in order to conform to personal identifying information (PII) governing laws (thereby avoiding post-processing being performed once received at the at centralized system to perform the encryption). In another example, the transformation may comprise first auditing governing rules to then propose compliance rules that contents transmitted to the centralized system must adhere to. At least some of the analyzed metadata may be transformed by clipping data from a packet that is eventually output to the centralized system, where the clipped data cannot be transferred based on International Traffic in Arms Regulations (ITAR) regulations. This clipping prevents the data from being ingested by other unauthorized entities and violating the regulations. In some approaches, the tag and/or label may indicate that such data was clipped, and specify metadata analysis operations that must be performed locally on the centralized system in order to conform to the regulations. This transformation avoid transmission of portions of metadata that would otherwise violate the laws such as the PII governing laws. In some other approaches, historical use of metadata on the centralized system may be evaluated to statistically predict relatively likely uses of the analyzed metadata. In some approaches, this evaluation includes probing logs of the centralized system and determining whether a current state of the metadata conforms or not to historical use cases of identified in the logs.

The transformation of the analyzed metadata may additionally and/or alternatively include encrypting the analyzed metadata, appending a first tag of the first set of tags to the analyzed metadata to indicate acceptable destinations for the first set of tags and the analyzed metadata, appending a second tag of the first set of tags to the analyzed metadata to indicate unacceptable destinations for the first set of tags and the analyzed metadata, etc., In yet another approach, the transformation of the analyzed metadata may additionally and/or alternatively include adding a classification and a sensitivity level for data present in the files and/or the objects associated with the analyzed metadata. Such classifications and/or sensitivity levels may, in some approaches, be caused to be performed by the centralized system providing current role based access control (RBAC) information to the edge sites along with instructions for using the information to perform the classifications and determined sensitivity levels.

Operation 308 includes causing storage of a dataset locally on the edge sites. In some approaches, causing storage of a dataset locally on the edge sites comprises issuing an instruction (by the centralized system) for the edge sites to create relatively small local databases for structuring of the analyzed metadata. Creation of the local database, in some approaches, includes setting up a lightweight database on one or more of the edge sites themselves (e.g., by issuing an SQLite and/or a small NoSQL store function). Here the lightweight databases may be used to store the extracted metadata, tags, and clustering results in a structured format. For example, the structured format may include, e.g., tables with columns such as file name, size, category, tags, etc. In some approaches, the lightweight database on one or more of the edge sites may additionally and/or alternatively be used to store and structure the analyzed metadata. For example, the metadata may be stored in a structured format (such as JSON or CSV) to represent the tags, clusters, and raw metadata alongside a unique identifier of files associated with the metadata (e.g., file path or object ID).

Operation 310 includes causing the edge sites to merge and/or compare the tags to identify a consolidated second set of tags and a portion of the analyzed metadata. This comparison may additionally and/or alternatively include causing a comparison of distributed metadata at the multiple edge nodes in the edge network to be compared by the edge sites, e.g., result of the scanning and/or clustering. For context, this comparison may be performed to determine whether any of the edge sites have tags and/or metadata that match other tags and/or metadata of another of the edge sites. In other words, in order to prevent copies of the same data from being transmitted to the centralized system, the comparison may be performed in order to relatively reduce a transmission workload, e.g., an inter-entity metadata consolidation procedure is caused to be performed.

In some approaches, in order to cause this merge and/or comparison to be performed, metadata and/or tags are shared across the edge sites. This sharing may be performed by communication being established between the edge sites to exchange metadata and tag proposals, e.g., an AI model may instruct communication paths and/or handshakes to be performed between the edge sites. In some approaches, these communication paths may additionally and/or alternatively be established by performing peer-to-peer (P2P) protocols (of a type that would become apparent to one of ordinary skill in the art after reading the descriptions herein) and/or or a central lightweight hub to synchronize data.

In order to cause this merge and/or comparison to be performed, method 300 may additionally and/or alternatively include causing the edge sites to merge and compare the tags, e.g., compare the first set of tags to identify a consolidated second set of tags and a portion of the analyzed metadata. In this process, each edge entity shares its metadata clusters and proposed tags with the other edge sites in the network. Then, an analysis across the edge sites is performed to identify common clusters and/or discrepancies. Unique clusters and/or discrepancies may, in some approaches, be candidates for including in the second set of tags and a portion of the analyzed metadata while common clusters may be identified, and a single one of the common clusters may be included in the second set of tags and a portion of the analyzed metadata.

To propose consolidated tags, after merging data from any number of the edge sites, a consolidated set of tags that better represents the combined dataset may be proposed. This step, in some approaches, refines metadata by considering a relatively wider context of all the entities. This context may, in some approaches, be determined by considering the use case of the analyzed metadata. In response to a determination that this context reveals that only a subset of the tags and/or metadata may be needed, candidates for excluding content from the second set of tags and a portion of the analyzed metadata may be identified within the tags and/or metadata.

Although various approaches above describe the edge sites transforming the metadata during the analysis portion of method 300, in some approaches, before transmitting the data to the centralized system, method 300 may additionally and/or alternatively include instructing at least some of the edge sites to transform the analyzed metadata to conform to rules associated with identified scheduled and/or forecasted use case of the analyzed metadata, e.g., see operation 312. For context, this transformation may be performed based on the comparisons of the edge sites, as the comparison may provide at least some of the edge sites with rules associated with the identified scheduled and/or forecasted use case of the analyzed metadata, where the edge sites may not have previously had access to such rules. A result of this transformation includes the consolidated second set of tags and the portion of the analyzed metadata (where at least some of the first set of tags are filtered out based on the performed comparison in order to determine the consolidated second set of tags and the portion of the analyzed metadata).

Operation 314 includes causing conglomeration of metadata enrichment, e.g., conglomerate results of the analysis before transmission to the centralized system. In some approaches, this conglomeration include consolidating final metadata enrichment where all metadata and tagging results across all edge entities are consolidated into a single, cohesive dataset. In some approaches, the edge sites deduplicate any overlapping metadata and resolve conflicts in tags through majority voting and/or relatively more sophisticated consensus algorithms of a type that would become apparent to one of ordinary skill in the art after reading the descriptions herein. A unified data model may additionally and/or alternatively be created in this conglomeration process. This creation ensures that the data from all edge sites is structured uniformly, preparing it for relatively easy ingestion by the centralized system. This may involve mapping local edge schemas to a global schema using mapping techniques that would become apparent to one of ordinary skill in the art after reading the descriptions herein.

The data, metadata and/or tags considered by the edge sites may be packaged and/or compressed for transmitting to the centralized system, in some approaches. Data packaging and compression, in some approaches, includes package the structured metadata and enriched tags into a standardized format (e.g., JSON, XML, and/or a proprietary format). In some preferred approaches, during packaging and/or compression, the edge sites ensure the package includes any metadata relationships and linkage to the original files or objects. This way the tags and/or metadata may be used by the centralized system to fulfill queries, as will be described in greater detail elsewhere below.

A packaged, compressed and transmitted conglomeration of the tags and/or portion of the metadata analyzed by the edge sites (the consolidated second set of tags and the portion of the analyzed metadata) is transmitted to, and received at, the centralized system, e.g., see operation 316. For this data transfer, in some approaches, secure transfer protocols (e.g., HTTPS, SCP, MQTT) may be used (based on instructions and/or provided specifications to do so) to send the packaged data from each edge entity to the centralized system and/or cloud platform for further analysis and long-term storage.

Operation 318 includes ingesting and/or storing the consolidated second set of tags and the portion of the analyzed metadata at the centralized system. Regarding the ingestion, method 300 includes ingesting data into the central system by ingesting the consolidated second set of tags and the portion of the analyzed metadata at a centralized system (e.g., metadata enrichment ingestion). More specifically, in some approaches, in response to the consolidated data reaching the centralized system, the data is ingested into a large-scale database (e.g., a distributed NoSQL system and/or a data warehouse which may be of a type that would become apparent to one of ordinary skill in the art after reading the descriptions herein).

In some approaches, the centralized system performs a centralized analysis. For example, the centralized system may perform an additional, large-scale analysis (e.g., deep learning, large-scale clustering, and/or indexing) on the collected metadata provided by the edge sites.

Regarding the storage, the consolidated second set of tags and the portion of the analyzed metadata at the centralized system, in some approaches, the structured metadata, tags, and/or enriched data is stored at scale in a repository of the centralized repository, thereby making it available for queries, reporting, and future metadata enrichment processes. For example, in response to receiving, at the centralized system, a query for data present in the files and/or the objects associated with the analyzed metadata, the consolidated second set of tags and/or the portion of the analyzed metadata is used to fulfill the query, e.g., see operation 320. It should be noted that this query fulfillment is ultimately performed in a process that involves relatively less data transmission than would otherwise be achieved without using the techniques described herein for offloading the analysis of the metadata to the edge sites. Accordingly, the techniques described herein relatively reduce latency and network traffic within the edge network.

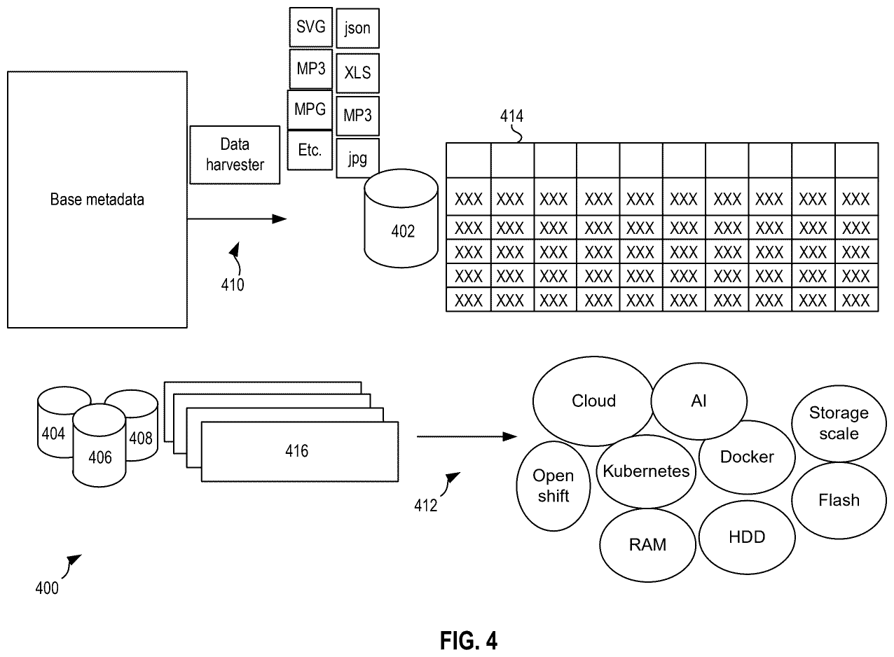

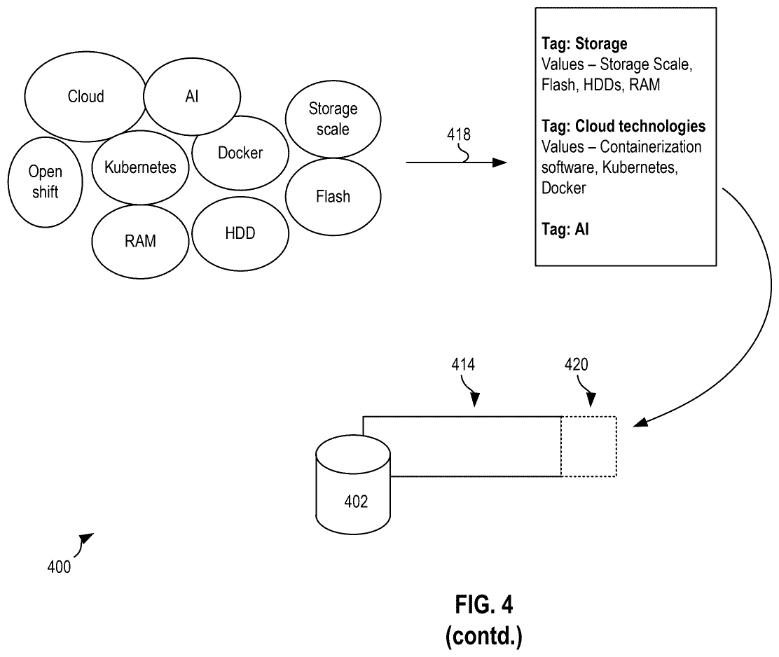

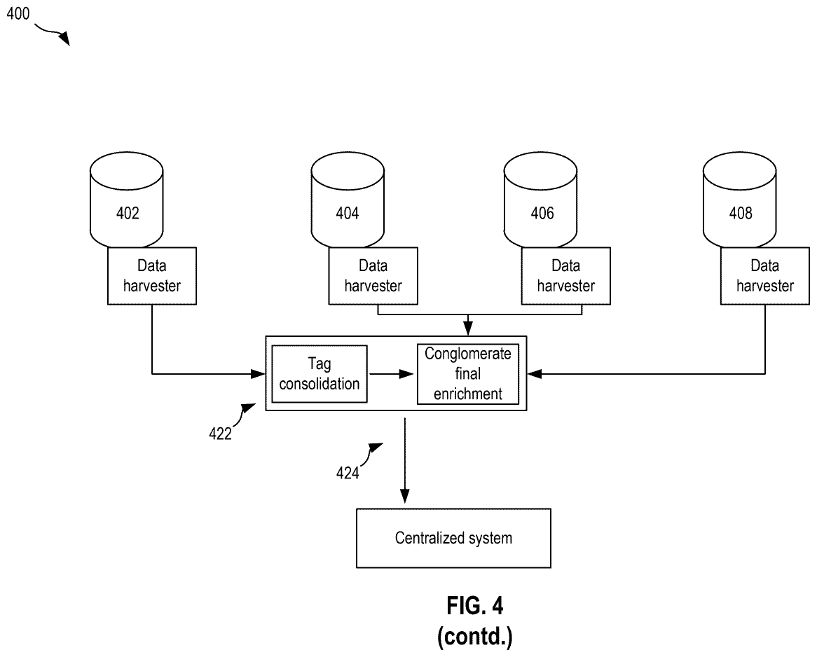

Now referring to FIG. 4, a flowchart of a method 400 is shown according to one embodiment. The method 400 may be performed in accordance with aspects of the present invention in any of the environments depicted in FIGS. 1-4, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

The operations of method 400 are similar to operations of method 300, however infrastructure components have been added to the flowchart of FIG. 4 to provide further context of the techniques herein. Furthermore, the operations of method 400 include techniques for performing distributed metadata enrichment ingestion for unstructured data at edge sites. For example, FIG. 4 illustrates a plurality of edge sites of an edge network, e.g., see a first edge site 402, a second edge site 404, a third edge site 406 and an n^{th} edge site 408. Each of the edge sites have a data harvester that may be instructed to cause the plurality of edge sites of the edge network to analyze metadata extracted from the edge sites.

The edge sites are caused to perform the metadata analysis rather than a centralized system of the edge network, e.g., see extraction from base metadata in operation 410. In some approaches, this analysis is enabled by instructing the edge sites to perform file and object edge metadata scanning.

While centralized enrichment by the centralized system may be otherwise possible, performing the analysis on the centralized system would otherwise become a bottleneck in large-scale, distributed environments, where data is being generated and stored at the edge (e.g., remote locations, IoT devices, edge servers). In such cases, otherwise transmitting large volumes of data back to a repository of the centralized system for processing is inefficient, slow, and costly, especially when dealing with 50 PB or more of data, where files are distributed across various locations. Accordingly, to mitigate these issues of the centralized approach, to enrich metadata, the techniques described herein may be adopted as an edge computing strategy for data enrichment.

A result of the performed analysis performed by the edge sites may be used to create base metadata catalogs for the edge sites, e.g., see base metadata catalogs 414 and 416. Note that the “XXX” of the base metadata catalogs 414 represent different types of metadata, e.g., names, subjects, categories, created timestamps, modified timestamps, etc. Furthermore, the analysis, in some approaches, includes performing metadata analytics for generating ranking tags and labels from different scans at the edge sites, e.g., see operation 412. In some approaches, this includes performing data analytics on the metadata to suggest metadata enrichment over ingested data at the edge sites. This enrichment, in some approaches, is provided by causing the edge sites to set up a context and transmitting the determined context to other peer edge sites to ease the optimization function in establishing clustering and tags proposal. For example, clusters Cloud, AI, HDD, etc., may be used to determine suggested candidate tags and clusters, e.g., see operation 418. In some approaches, base metadata clustering is performed for tags which offer data suggestions based on determined similarities and context-aware clustering. In some further approaches, the edge sites may be caused to process different types of metadata and perform context-aware enrichment, and then report results to a central control plane that is caused, e.g., instructed, to aggregate the enriched data processed.

Tags and/or the analyzed metadata may be compared to determine how to transform the metadata and/or tags in order to expand the local data metadata content, e.g., see added portion 420.

In operation 422 the transformed tags and/or metadata are consolidated using techniques described elsewhere herein to establish a conglomerated final enriched second set of tags and the portion of the analyzed metadata. This packet is then transmitted to the centralized system, e.g., see operation 424. Note that, in some approaches, a trained AI model, which may be of the centralized system, may be used to orchestrate a single or multiple of the edge sites for ensuring having plurality of metadata enriched by proposed tags. This way, the edge sites are instructed to perform distributed tags association to complement base metadata through context-aware tags being consolidated with the unstructured data completing the enrichment.

Benefits of the techniques described in method 400 (as well as method 300) include the data being processed relatively closer to a source (at the edge), meaning that the metadata can be enriched locally without having to transfer it all back to the centralized system. Furthermore, edge devices and/or edge servers (the edge sites) can be equipped with the computational power needed to analyze and enrich the metadata directly. This way, enrichment at scale becomes feasible, as the load is distributed across multiple edge sites (nodes), reducing latency, saving bandwidth, and speeding up the process. By adopting an edge-based data enrichment strategy, companies can perform analysis and add valuable context to the data closer to where it is generated. This is especially advantageous in scenarios where real-time insights or low-latency responses are required, such as in IoT systems, autonomous vehicle networks, and/or smart manufacturing processes.

Benefits of the edge site data enrichment described herein includes scalability. This is because edge processing scales relatively more easily by distributing the load across multiple edge sites. Furthermore, these benefits extend to real-time insights. This is because enriching data at the edge allows for relatively quicker decision-making, especially when real-time analysis is needed. These benefits further include an overall reduced bandwidth and costs within the edge network. This is because large data transfers back to the centralized system are avoided, which minimizes bandwidth usage and reduces operational costs. These benefits yet furthermore include resilience. This is because edge sites can continue to operate and enrich data even if connectivity to the centralized system is temporarily lost. By shifting enrichment to the edge sites, these techniques are well-suited for managing data at a massive scale, making it highly relevant in decentralized, data-rich environments.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
causing edge sites of an edge network to analyze metadata extracted from the edge sites;
causing the edge sites to propose a first set of tags for files and/or objects associated with the analyzed metadata, wherein the first set of tags are based on the analysis;
causing the edge sites to merge and/or compare the tags to identify a consolidated second set of tags and a portion of the analyzed metadata; and
ingesting the consolidated second set of tags and the portion of the analyzed metadata at a centralized system, wherein the centralized system does not contribute to the analysis of the analyzed metadata.

2. The method of claim 1, wherein the causing the edge sites to propose the first set of tags for the files and/or the objects associated with the analyzed metadata comprises: identifying a scheduled and/or forecasted use case of the analyzed metadata, and comprising: instructing at least some of the edge sites to transform the analyzed metadata to conform to rules associated with the identified scheduled and/or forecasted use case of the analyzed metadata.

3. The method of claim 2, wherein the identifying the scheduled and/or forecasted use case of the analyzed metadata comprises: associating business and/or technical contexts with data present in the files and/or the objects associated with the analyzed metadata.

4. The method of claim 2, wherein transformation of the analyzed metadata is selected from the group consisting of: encrypting the analyzed metadata, appending a first tag of the first set of tags to the analyzed metadata to indicate acceptable destinations for the first set of tags and the analyzed metadata, appending a second tag of the first set of tags to the analyzed metadata to indicate unacceptable destinations for the first set of tags and the analyzed metadata, and adding a classification and a sensitivity level for data present in the files and/or the objects associated with the analyzed metadata.

5. The method of claim 1, further comprising:
in response to receiving, at the centralized system, a query for data present in the files and/or the objects associated with the analyzed metadata, using the consolidated second set of tags to fulfill the query.

6. The method of claim 1, wherein the analysis of the metadata extracted from the edge sites was initially scheduled to be performed by the centralized system.

7. The method of claim 1, further comprising:
using a training set of data to train an artificial intelligence (AI) model to analyze the edge sites to dynamically determine available processing resources of the edge sites; and
in response to a determination that the AI model achieves at least a predetermined threshold of accuracy of analyzing the edge sites to dynamically determine the available processing resources of the edge sites, deploying the AI model.

8. The method of claim 7, wherein the files and/or objects are distributed across the edge sites, and further comprising:
obtaining, from the AI model, the available processing resources of the edge sites,
wherein the causing the edge sites to analyze the metadata extracted from the edge sites comprises: instructing the edge sites to perform portions of the analysis, wherein the portions of the analysis are proportional to the available processing resources of the edge sites.

9. The method of claim 8, wherein the causing the edge sites to analyze the metadata extracted from the edge sites comprises: instructing the edge sites to perform multiprocessing to perform the portions of the analysis.

10. A computer program product comprising:
one or more computer-readable storage media; and
program instructions stored on the one or more storage media to perform operations comprising:
causing edge sites of an edge network to analyze metadata extracted from the edge sites;
causing the edge sites to propose a first set of tags for files and/or objects associated with the analyzed metadata, wherein the first set of tags are based on the analysis;
causing the edge sites to merge and/or compare the tags to identify a consolidated second set of tags and a portion of the analyzed metadata; and
ingesting the consolidated second set of tags and the portion of the analyzed metadata at a centralized system, wherein the centralized system does not contribute to the analysis of the analyzed metadata.

11. The computer program product of claim 10, wherein the causing the edge sites to propose the first set of tags for the files and/or the objects associated with the analyzed metadata comprises: identifying a scheduled and/or forecasted use case of the analyzed metadata, and comprising: instructing at least some of the edge sites to transform the analyzed metadata to conform to rules associated with the identified scheduled and/or forecasted use case of the analyzed metadata.

12. The computer program product of claim 11, wherein the identifying the scheduled and/or forecasted use case of the analyzed metadata comprises: associating business and/or technical contexts with data present in the files and/or the objects associated with the analyzed metadata.

13. The computer program product of claim 11, wherein transformation of the analyzed metadata is selected from the group consisting of: encrypting the analyzed metadata, appending a first tag of the first set of tags to the analyzed metadata to indicate acceptable destinations for the first set of tags and the analyzed metadata, appending a second tag of the first set of tags to the analyzed metadata to indicate unacceptable destinations for the first set of tags and the analyzed metadata, and adding a classification and a sensitivity level for data present in the files and/or the objects associated with the analyzed metadata.

14. The computer program product of claim 10, wherein the operations further comprise:
in response to receiving, at the centralized system, a query for data present in the files and/or the objects associated with the analyzed metadata, using the consolidated second set of tags to fulfill the query.

15. The computer program product of claim 10, wherein the analysis of the metadata extracted from the edge sites was initially scheduled to be performed by the centralized system.

16. The computer program product of claim 10, wherein the operations further comprise:
using a training set of data to train an artificial intelligence (AI) model to analyze the edge sites to dynamically determine available processing resources of the edge sites; and
in response to a determination that the AI model achieves at least a predetermined threshold of accuracy of analyzing the edge sites to dynamically determine the available processing resources of the edge sites, deploying the AI model.

17. The computer program product of claim 16, wherein the files and/or objects are distributed across the edge sites, wherein the operations further comprise:
obtaining, from the AI model, the available processing resources of the edge sites,
wherein the causing the edge sites to analyze the metadata extracted from the edge sites comprises: instructing the edge sites to perform portions of the analysis, wherein the portions of the analysis are proportional to the available processing resources of the edge sites.

18. The computer program product of claim 17, wherein the causing the edge sites to analyze the metadata extracted from the edge sites comprises: instructing the edge sites to perform multiprocessing to perform the portions of the analysis.

19. A computer system comprising:
a processor set;
one or more computer-readable storage media; and
program instructions stored on the one or more storage media to cause the processor set to perform operations comprising:
causing edge sites of an edge network to analyze metadata extracted from the edge sites;
causing the edge sites to propose a first set of tags for files and/or objects associated with the analyzed metadata, wherein the first set of tags are based on the analysis;
causing the edge sites to merge and/or compare the tags to identify a consolidated second set of tags and a portion of the analyzed metadata; and
ingesting the consolidated second set of tags and the portion of the analyzed metadata at a centralized system, wherein the centralized system does not contribute to the analysis of the analyzed metadata.

20. The computer system of claim 19, wherein the causing the edge sites to propose the first set of tags for the files and/or the objects associated with the analyzed metadata comprises: identifying a scheduled and/or forecasted use case of the analyzed metadata, and comprising: instructing at least some of the edge sites to transform the analyzed metadata to conform to rules associated with the identified scheduled and/or forecasted use case of the analyzed metadata.
